(19) United States
(12) Patent Application Publication
(10) Pub. No.: US 2010/0103233 A1
(43) Pub. Date: Apr. 29, 2010

(54) LIQUID EJECTING APPARATUS

(75) Inventors: Yasushi AKATSUKA, Higashitikuma-gun (JP); Hitotoshi KIMURA, Matsumoto-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/604,262

(22) Filed: Oct. 22, 2009

(30) Foreign Application Priority Data
Oct. 23, 2008 (JP) 2008-272810
Jul. 27, 2009 (JP) 2009-174305

(51) Int. Cl. B41J 2/19

(52) U.S. Cl. 347/92

(57) ABSTRACT

A liquid ejecting apparatus includes: a liquid container which contains a liquid; a liquid ejecting unit which ejects the liquid supplied from the liquid container; a cavitation generator which generates cavitation in the liquid; and a gas discharging port which discharges a gas separated from the liquid by the cavitation.

### BACKGROUND

1. Technical Field

The present invention relates to a liquid ejecting apparatus capable of concurrently stirring and deaerating a liquid in a continuous manner.

2. Related Art

In general, as ink used in a printing apparatus which is a kind of a liquid ejecting apparatus, there is known ink in which a color component which is not dissolved in a solvent or a color component rarely dissolved in a solvent is used. For example, as for pigment-based ink, pigment is easily deposited since fine particles of the pigment used as a color component are dispersed in a solvent such as water or petroleum solvent. Specifically, the specific gravity of a white color pigment is about 4 and the specific gravity of a metallic pigment is in the range of about 2 to about 3, whereas the specific gravity of a solvent is about 1 or less. Moreover, a specific gravity between the pigment and the solvent is 1 or more. Therefore, the pigment is easily deposited.

Even in ink in which insoluble colorant or hardly-soluble colorant is used as a color component, the colorant is easily deposited. When the color component of the ink is deposited, non-uniformity may occur in the concentration of the ink and thus it is difficult to supply the ink of uniform concentration to a head. Therefore, since the nozzles of the head may become clogged due to the high concentration of ink, a problem may arise in that the ink hardly drops from the nozzles or the brightness of dots are changed (an L asterisk is lowered).

In order to solve this problem, numerous techniques have been suggested for preventing the deposition of a color component by stirring ink (for example, JP-A-2002-200765 and JP-A-2002-192742). JP-A-2002-200765 discloses a technique in which a propeller rotates to stir ink in an ink containing bag. JP-A-2002-192742 discloses a technique in which vibration produced by piezoelectric elements is applied to ink in an ink containing bag.

In printing apparatuses disclosed in JP-A-2002-200765 and JP-A-2002-192742, however, it is difficult to remove the gas dissolved in the ink. This is because the ink is not concurrently stirred and deaerated in a continuous manner just by stirring the ink. For this reason, when bubbles are generated in the ink, a problem may arise in that an ink passage or the nozzles of the head become blocked which could lead to an ink ejection failure or a printing failure.

### SUMMARY

An advantage of some aspects of the invention is that it provides a liquid ejecting apparatus capable of concurrently stirring and deaerating a liquid in a continuous manner.

According to an aspect of the invention, there is provided a liquid ejecting apparatus including: a liquid container which contains a liquid; a liquid ejecting unit which ejects the liquid supplied from the liquid container; a cavitation generator which generates cavitation in the liquid; and a gas discharging port which discharges a gas separated from the liquid by the cavitation.

According to this aspect of the invention, the gas separated from the liquid is discharged from the gas discharging port. Accordingly, it is possible to concurrently stir and deaerate the liquid in a continuous manner.

In the liquid ejecting apparatus according to the aspect of the invention, the cavitation generator may be disposed in a liquid passage permitting the liquid container to communicate with the liquid ejecting unit.

According to this aspect of the invention, since the cavitation generator is disposed at a position close to the liquid ejecting unit in the liquid passage, the stirred and deaerated liquid can be supplied to the liquid ejecting unit rapidly. In particular, the supply is effective in a case where a distance between the liquid container and the liquid ejecting unit is long.

In the liquid ejecting apparatus according to the aspect of the invention, the cavitation generator may be disposed in the liquid ejecting unit.

According to this aspect of the invention, since the liquid can be stirred and deaerated in the liquid ejecting unit, it is possible to supply the stirred and deaerated liquid to the nozzles of the liquid ejecting unit rapidly. In particular, the supply is effective in the case where a distance between the liquid container and the liquid ejecting unit is long.

In the liquid ejecting apparatus according to the aspect of the invention, the cavitation generator may be disposed in the liquid container.

According to this aspect of the invention, it is possible to supply the stirred and deaerated liquid to the liquid ejecting unit. In this case, when the distance between the liquid container and the liquid ejecting unit is made shorter, it is possible to supply the stirred and deaerated liquid to the liquid ejecting unit rapidly.

In the liquid ejecting apparatus according to the aspect of the invention, the cavitation generator may include a stirrer unit which stirs the liquid and a driving unit which drives the stirrer unit.

According to this aspect of the invention, the cavitation can effectively be generated by driving the stirrer unit by the driving unit.

In the liquid ejecting apparatus according to the aspect of the invention, the cavitation generator may include a liquid stirring chamber, a stirrer unit which stirs the liquid in the liquid stirring chamber, and a driving unit which drives the stirrer unit.

According to this aspect of the invention, since the cavitation can be generated intensively in the liquid stirring chamber, it is possible to effectively stir and deaerate the liquid.

In the liquid ejecting apparatus according to the aspect of the invention, the liquid stirring chamber may include a lower chamber which has a cylinder shape extending vertically and an upper communication passage which permits the lower chamber to communicate with the gas discharging port.

According to this aspect of the invention, since the contact area of the liquid with the air can be made small, it is possible to suppress the dissolution of the air in the liquid. On the other hand, when the liquid stirring chamber is made larger, it is possible to effectively stir and deaerate the liquid.

In the liquid ejecting apparatus according to the aspect of the invention, a passage diameter of the upper communication passage may be smaller than a cylinder diameter of the lower chamber.

According to this aspect of the invention, since the passage diameter of the upper communication passage can be made smaller and the liquid stirring chamber can be made larger, it is possible to effectively stir and deaerate the liquid, while suppressing the dissolution of the air in the liquid.

The liquid ejecting apparatus according to the aspect of the invention may further include an exhauster which exhausts the gas from the gas discharging port. The exhauster may include a lower on-off valve which is disposed in a lower portion of the upper communication passage and opens or closes the upper communication passage, an upper on-off valve which is disposed in an upper portion of the upper communication passage and opens or closes the upper communication passage, a liquid level detecting unit which detects whether a liquid surface of the liquid in the liquid stirring chamber reaches the upper communication passage between the lower on-off valve and the upper on-off valve, and a liquid level changing unit which upwardly moves the liquid surface of the liquid in the liquid stirring chamber.

According to this aspect of the invention, the bubbles (gas) can be isolated in the upper communication passage between the lower on-off valve and the upper on-off valve by closing the lower on-off valve and the upper on-off valve. Therefore, it is possible not to return the poor liquid containing the bubbles (gas) backwardly to the liquid stirring chamber. In this case, by opening the upper on-off valve, the bubbles (gas) in the upper communication passage can easily be discharged from the gas discharging port to the air. Moreover, the liquid level sensor can exactly determine whether the bubbles are generated near the liquid surface of the liquid by detecting whether the liquid surface of the liquid reaches the regular position. Therefore, it is possible to reliably perform the discharging process at an appropriate time. In this case, by moving the liquid level upwardly by the liquid level changing unit, it is possible to perform the discharging process rapidly.

According to another aspect of the invention, there is provided a liquid ejecting apparatus including: a liquid ejecting unit which is connected to a liquid container containing a liquid through a liquid passage and ejects the liquid; a liquid stirring chamber which is disposed in the liquid passage and stirs the liquid; a stirring blade which is disposed in the liquid stirring chamber and rotates to stir the liquid in the liquid stirring chamber; and a gas discharging port which discharges a gas from the liquid stirring chamber, when the liquid near the stirring blade is depressurized by the rotation of the stirring blade and thus the gas dissolved in the liquid is separated from the liquid.

According to this aspect of the invention, since the liquid near the stirring blade is depressurized by rotating the stirring blade, the gas dissolved in the liquid becomes the bubbles and is discharged from the gas discharging port. Accordingly, it is possible to concurrently stir and deaerate the liquid in the continuous manner.

In the liquid ejecting apparatus according to the above aspect of the invention, a rotation speed of the stirring blade when the liquid in the liquid stirring chamber is stirred by the stirring blade may be set to be slower than a rotation speed of the stirring blade when the liquid near the stirring blade is depressurized. The stirring blade may be configured to generate an axial stream generated in a vertical direction by the rotation of the stirring blade. A rotation direction of the stirring blade may be a direction in which the liquid in the liquid stirring chamber flows toward an upper portion of the liquid stirring chamber by the axial stream generated by the rotation of the stirring blade.

According to this aspect of the invention, since the liquid below the stirring blade is easily depressurized by rotating the stirring blade, the gas dissolved in the liquid also becomes the bubbles at a region below the stirring blade. Accordingly, since it takes a distance for the bubbles to rise toward the upper portion of the liquid stirring chamber, it is possible to obtain the liquid stirring effect by the bubbles.

In the liquid ejecting apparatus according to the above aspect of the invention, the stirring blade may be disposed near a bottom surface of the liquid stirring chamber.

According to this above aspect of the invention, the bubbles are generated near the bottom surface of the liquid stirring chamber by rotating the stirring blade. Accordingly, since it takes a distance for the bubbles to rise toward the upper portion of the liquid stirring chamber, it is possible to obtain the liquid stirring effect by the bubbles.

In the liquid ejecting apparatus according to the above aspect of the invention, the gas discharging port may be disposed in the upper portion of the liquid stirring chamber and the liquid passage is connected to a position below the stirring blade in the liquid stirring chamber.

According to this aspect of the invention, since the bubbles generated near the stirring blade by the rotation of the stirring blade rise toward the upper portion of the liquid stirring chamber with the gas discharging port, the bubbles rarely enter the liquid passage connected to the liquid stirring chamber at the position below the stirring blade. Accordingly, it is possible to prevent the bubbles generated near the stirring blade from entering the liquid container and the liquid ejecting unit via the liquid passage.

### BRIEF DESCRIPTION OF THE DRAWINGS

The invention will be described with reference to the accompanying drawings, wherein like numbers reference like elements.

FIG. 1 is a diagram illustrating the configuration of a printing apparatus (according to an embodiment).

FIG. 2 is a sectional view illustrating an ink cartridge and a head (according to the embodiment).

FIG. 3 is a flowchart illustrating a stirring deaeration process routine (according to the embodiment).

FIG. 4 is a diagram illustrating the configuration of a printing apparatus (according to Other Embodiment 1).

### DESCRIPTION OF EXEMPLARY EMBODIMENTS

Hereinafter, a printing apparatus according to an embodiment of the invention will be described with reference to the drawings.

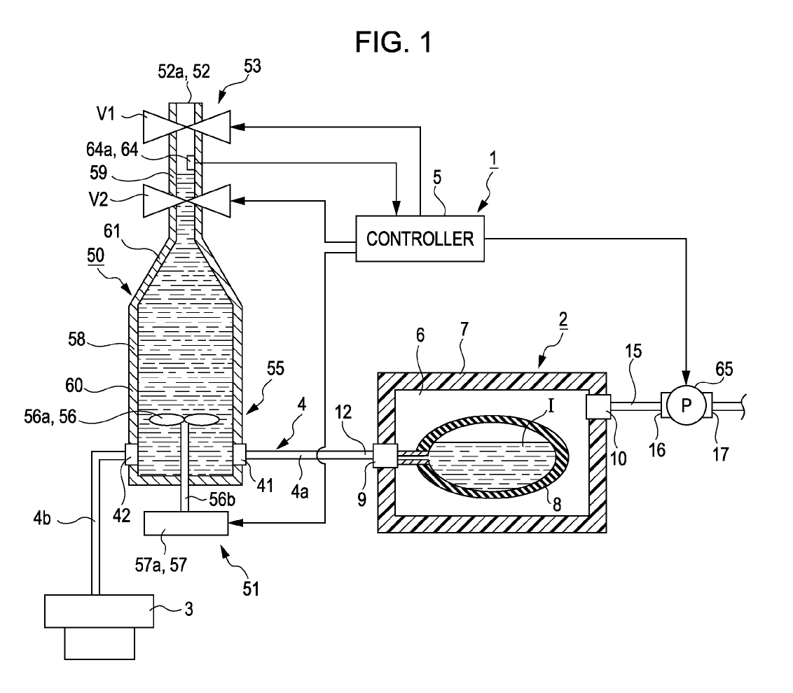

FIG. 1 is a diagram illustrating the configuration of a printing apparatus. As shown in FIG. 1, a printing apparatus 1, which is a liquid ejecting apparatus, includes an ink cartridge 2 (hereinafter, referred to as a cartridge), which is a liquid container for containing ink I (hereinafter, referred to as ink without attaching the sign), which is a liquid, a head 3 which is a liquid ejecting unit, an ink passage 4 which is a liquid passage permitting the cartridge 2 to communicate with the head 3, and a pump P which is a liquid level changing unit 65, a controller 5, and a stirring deaerator 50 which is disposed in the ink passage 4. In the ink passage 4, a passage between the stirring deaerator 50 and the cartridge 2 is used as a cartridge-side ink passage 4a and a passage between the stirring deaerator 50 and the head 3 is used as a head-side ink passage 4b.

The cartridge 2 is detachably mounted on a base body of the printing apparatus 1. The cartridge 2 is detachably mounted on a carriage which is a driving unit or detachably mounted on a fixing section of a casing of the printing apparatus 1. The cartridge 2 is replaced when the ink is completely consumed. The cartridge 2 includes a container 7 which forms a pressure chamber 6 and a containment bag body 8 which is disposed within the pressure chamber 6 and contains ink therein. The container 7 includes a container-side ink entrance port 9, which is made of a hard material such as hard plastic and preserves a bag-side ink entrance port 12, which is described below, and an air supply port 10 which permits the inside of the pressure chamber 6 to communicate with the outside.

The containment bag body 8 is formed of a thin bag of which an ink containing volume is variable and which is made of a material with flexibility, such as butyl rubber, polysulfide rubber, epichlorohydrin rubber, high nitride rubber, fluoro-rubber, or the like, and with a gas impermeable property of not permeating a gas. The containment bag body 8 includes the bag-side ink entrance port 12. The bag-side ink entrance port 12 is fixed to the container 7 so as to pass through the container-side ink entrance port 9 and be connected to the outside of the container 7.

One end of the cartridge-side ink passage 4a is connected to the bag-side ink entrance port 12 of the containment bag body 8 so that the cartridge-side ink passage 4a and the containment bag body 8 communicate with each other. One end of the air supply passage 15 is connected to the air supply port 10. The other end of the air supply passage 15 is connected to a discharge port 16 of the pump P. A suction port 17 of the pump P is opened to the air. Air is supplied to the pressure chamber 6 through the air supply passage 15 by the drive of the pump P.

One end of the cartridge-side ink passage 4a is connected to the bag-side ink entrance port 12 of the containment bag body 8 and the other end of the cartridge-side ink passage 4a is connected to an ink entrance port 41 of an ink stirring chamber 55, which is described below. One end of the head-side ink passage 4b is connected to the ink exit port 42 of the ink stirring chamber 55 and the other end of the head-side ink passage 4b is connected to the head 3. Accordingly, the ink supplied from the cartridge 2 to the ink stirring chamber 55 of the stirring deaerator 50 via the cartridge-side ink passage 4a is supplied to the head 3 via the head-side ink passage 4b after the ink is stirred and deaerated by the stirring deaerator 50.

The stirring deaerator 50 includes a cavitation generator 51 which generates cavitation in the ink, a gas discharging port 52 which discharges the gas separated from the ink by the cavitation, and an exhauster 53 which exhausts the gas from the gas discharging port 52.

The cavitation generator 51 includes the ink stirring chamber 55, a stirrer unit 56 which stirs the ink in the ink stirring chamber 55, and a driving unit 57 which drives the stirrer unit 56. The ink stirring chamber 55 includes a cylindrical lower chamber 58 which extends vertically and an upper communication passage 59 which permits the inside of the lower chamber 58 to communicate with the gas discharging port 52 located in the upper end of the ink stirring chamber 55. In this case, the gas discharging port 52 is formed by an upper end opening 52a of the upper communication passage 59. The lower chamber 58 includes a cylindrical section 60 which has the same diameter and a bottom and a conoid section 61 which has a substantially conoid shape connected to the upper end of the cylindrical section 60 and the lower end of the upper communication passage 59.

The upper communication passage 59 is formed of a passage having the same diameter and extending vertically. The passage diameter of the upper communication passage 59 is smaller than the cylinder diameter of the lower chamber 58. That is, the shape of the ink stirring chamber 55 is likened to that of a beer bottle. The stirrer unit 56 includes a propeller type stirring blade 56a disposed so as to be rotatable near the bottom surface of the lower chamber 58. In this case, the stirring blade 56a is disposed so as be located above the ink entrance port 41 and the ink exit port 42 of the ink stirring chamber 55. Accordingly, the cartridge-side ink passage 4a and the head-side passage 4b are connected at the positions below the stirring blade 56a in the ink stirring chamber 55.

The rotation shaft line of the stirring blade 56a extends vertically and the stirring blade 56a rotates in a predetermined rotation direction so that an axial stream in which the ink in the ink stirring chamber 55 flows toward the upper portion of the ink stirring chamber 55 is generated. That is, the stirring blade 56a rotates in a direction (the predetermined rotation direction) in which the ink in the ink stirring chamber 55 flows toward the upper portion of the ink stirring chamber 55.

The driving unit 57 includes a motor 57a. The stirring blade 56a is connected to the front end of the rotation shaft 56b which is an output shaft of the motor 57a. Accordingly, the stirring blade 56a is configured to rotate in the predetermined rotation direction on the rotation shaft 56b by driving the motor 57a.

The exhauster 53 includes a lower on-off valve V2, an upper on-off valve V1, a liquid level detecting unit 64, and a liquid level changing unit 65. The lower on-off valve V2 is disposed in the lower portion of the upper communication passage 59 and opens the upper communication passage 59. The upper on-off valve V1 is disposed in the upper portion of the upper communication passage 59 and opens the upper communication passage 59. The liquid level detecting unit 64 employs a liquid level sensor 64a which allows a sensor head (not shown) to send supersonic waves toward the liquid surface of the ink and to again receive the supersonic waves reflected from the liquid surface of the ink, measures a period of time taken to send the supersonic waves and to receive the reflected supersonic waves, calculates a distance of the liquid surface of the ink, and detects the position of the liquid surface of the ink.

The liquid level sensor 64a is disposed between the upper on-off valve V1 and the lower on-off valve V2 in the upper communication passage 59, for example, and detects whether the liquid surface of the ink in the ink stirring chamber 55 reaches a regular position. The regular position is determined between the upper on-off valve V1 and the lower on-off valve V2 in the upper communication passage 59 and below the liquid level sensor 64a.

In the cartridge 2, the bag-side ink entrance port 12 in a non-used state is sealed by a sealing film (not shown). One end of the cartridge-side ink passage 4a is provided with an ink supply needle (not shown). When the cartridge 2 is mounted in the printing apparatus 1, the ink supply needle tears the sealing film, and thus the ink in the containment bag body 8 of the cartridge 2 is supplied to the head 3 via a middle hollow passage of the ink supply needle, the cartridge-side ink passage 4a, the stirring deaerator 50, and the head-side ink passage 4b.

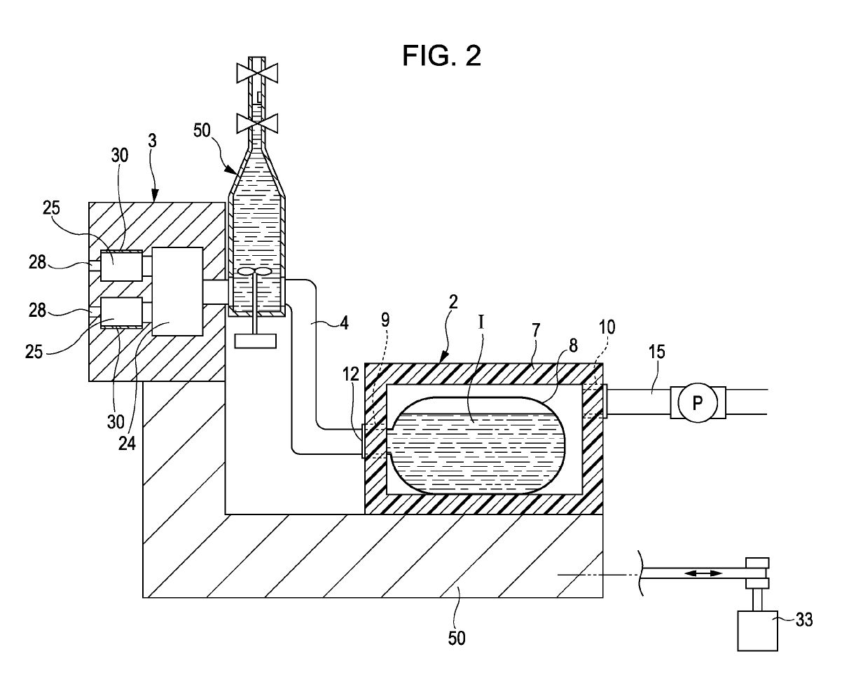

As shown in FIG. 2, the head 3 includes an ink chamber 24, pressure chambers 25, nozzles 28, and actuators 30. The other end of the head-side ink passage 4b is connected to an opening in one end of the ink chamber 24 in a communication state. An opening in one end of each pressure chamber 25 communicates with the ink chamber 24 and an opening in the other end of each pressure chamber 25 communicates with the nozzles 28.

The actuator 30 includes a piezoelectric element or a heating element disposed on the wall of the pressure chamber 25. The head 3 performs printing by forming a concave surface (meniscus) of the ink in the exit ports of the nozzles 28 by the ink supplied from the ink chamber 24 to the pressure chambers 25, extruding the ink in the nozzles 28 to form drops by the operation of the actuators 30, and landing the drops on a printing target such as a sheet.

The controller 5 includes a CPU, ROM, and a RAM and is electrically connected to the lower on-off valve V2, the upper on-off valve V1, the liquid level sensor 64a, the pump

P, and the motor 57a. The controller 5 controls the openness and closeness of the upper on-off valve V1 and the lower on-off valve V2 on the basis of a liquid level position signal from the liquid level sensor 64a. The controller 5 controls the drive of the pump P and the motor 57a. A variety of programs for controlling the drive of the printing apparatus 1 are stored in the ROM.

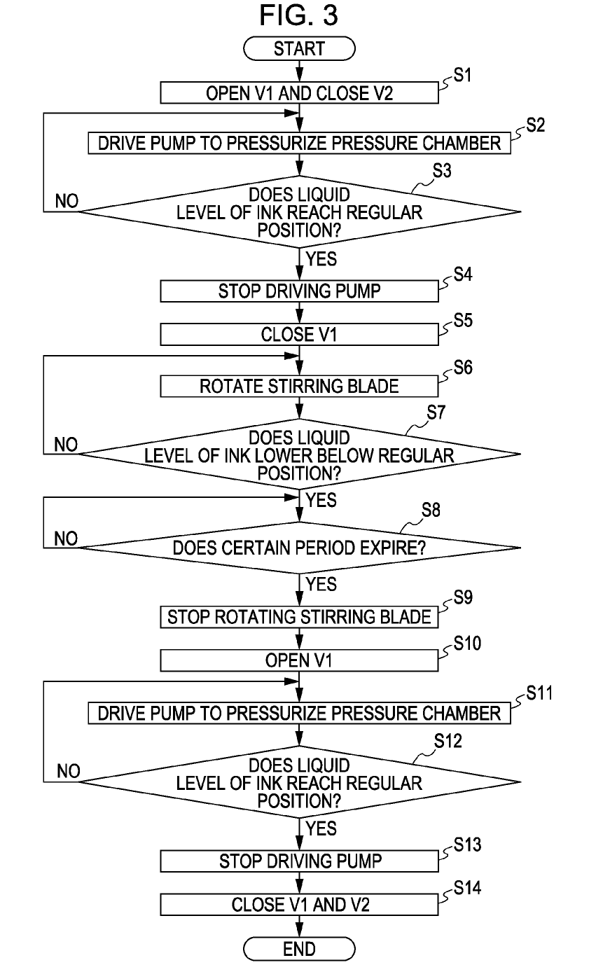

Next, a stirring deaeration process routine executed by the controller 5 will be described with reference to the flowchart of FIG. 3.

When the stirring deaeration process routine is executed, as shown in FIG. 3, the controller 5 first opens both the upper on-off valve V1 and the lower on-off valve V2 (step S1). Then, the ink stirring chamber 55 is opened to the air. Subsequently, the controller 5 drives the pump P to pressurize the pressure chamber 6 (step S2). Then, the containment bag body 8 is pressed (pressurized) from the outside to supply the ink in the containment bag body 8 to the lower chamber 58 of the ink stirring chamber 55 via the cartridge-side ink passage 4a.

Subsequently, the controller 5 determines whether the liquid surface of the ink in the ink stirring chamber 55 ascends and reaches the regular position on the basis of the liquid level position signal from the liquid level sensor 64a (step S3). When the determination is negative in step S3, the controller 5 allows the process to proceed to step S2. Alternatively, when the determination is positive in step S3, the controller 5 stops driving the pump P (step S4). Then, the supply of the ink to the lower chamber 58 is interrupted.

Subsequently, the controller 5 closes the upper on-off valve V1 (step S5), blocks the ink stirring chamber 55 from the air, and then drives the motor 57a to drive the stirring blade 56a (step S6). In this way, the ink is stirred in the ink stirring chamber 55. In this case, the ink is stirred by rotating the stirring blade 56a at a fast rotation speed corresponding to the degree of generating cavitation in the ink.

Then, since the ink is depressurized by the generated cavitation, a gas such as oxygen, nitrogen, carbon dioxide dissolved in the ink is separated from the ink and thus bubbles are generated. The bubbles rise and gather between the liquid surface of the ink and the upper on-off valve V1. In this case, the liquid surface of the ink lowers to the extent of the generation of the bubbles. Subsequently, the controller 5 determines whether the liquid surface of the ink in the ink stirring chamber 55 descends from the regular position on the basis of the liquid level position signal output from the liquid level sensor 64a (step S7).

When the determination is negative in step S7, the controller 5 allows the process to proceed to step S6. Alternatively, when the determination is positive in step S7, the controller 5 determines that a certain period expires (step S8). When the determination is negative in step S8, the controller 5 executes the process of step S8 again. Alternatively, when the determination is positive in step S8, the controller 5 stops the rotation of the stirring blade 56a (step S9).

Subsequently, the controller 5 opens the upper on-off valve V1 (step S10) and pressurizes the inside of the pressure chamber 6 by driving the pump P in the state where the ink stirring chamber 55 is opened to the air (step S11). Then, the ink in the containment bag body 8 is supplied to the lower chamber 58 of the ink stirring chamber 55, and thus the liquid surface of the ink in the ink stirring chamber 55 ascends. Subsequently, the controller 5 determines whether the liquid surface of the ink in the ink stirring chamber 55 ascends and reaches the regular position on the basis of the liquid level position signal from the liquid level sensor 64a (step S12).

When the determination is negative in step S12, the controller 5 allows the process to proceed to step S11. Alternatively, when the determination is positive in step S12, the controller 5 stops driving the pump P (step S13), closes the upper on-off valve V1 and the lower on-off valve V2 (step S14), and then ends the stirring deaeration process routine. In this case, since the controller 5 returns the liquid surface of the ink to the regular position, stops driving the pump P, and the closes the lower on-off valve V2, the poor ink containing the bubbles does not return to the ink stirring chamber 55.

In the stirring deaeration process routine, the shape of the stirring blade 56a and the rotation speed of the stirring blade 56a are configured so that the cavitation is generated in the ink in the ink stirring chamber 55. In addition, the cavitation is configured to be actively generated in the ink by stirring the ink in the ink stirring chamber 55 by the stirring blade 56a. Since the ink is depressurized due to the generation of the cavitation in the ink, the gas dissolved in the ink is separated in a gas phase. Since some gas generated by the cavitation remains dissolved again in the ink, the bubbles rise and thus the liquid surface of the ink descends after the cavitation.

After the liquid surface of the ink descends and then a certain period expires to spare time for the control, the stirring is stopped in a state where the liquid surface of the ink descends after the certain period. Therefore, by opening the upper on-off valve V1 and driving the pump P to pressurize the pressure chamber 6, the ink is supplied to the ink stirring chamber 55, the liquid surface of the ink ascends, and the bubbles gather in the liquid surface of the ink. When the liquid surface of the ink in the ink stirring chamber 55 ascends up to the regular position, the pressurizing is stopped and the upper on-off valve V1 and the lower on-off valve V2 are closed.

Therefore, the stirred and deaerated ink remains below the lower on-off valve V2 and the bubbles isolated by the lower on-off valve V2 gather above the lower on-off valve V2. The isolated bubbles are discharged to the air and thus removed by opening the upper on-off valve V1. That is, an exhausting process (a bubble removing process) is performed in such a manner in which the gas dissolved in the ink becomes the bubbles and then the bubbles are discharged to the air and removed before the bubbles are again dissolved in the ink.

In the specification, a process of stirring the ink by the stirrer unit 56 refers to a stirring process. Both a process of generating the cavitation and separating the gas dissolved in the ink and a process of discharging the separated bubbles refer to a deaerating process.

According to the above-described embodiment, the following advantages can be obtained.

(1) By rotating the stirring blade 56a in the ink stirring chamber 55 serving as an airtight container to generate the cavitation, it is possible to gather the bubbles generated in the ink stirring chamber 55 and discharge the bubbles in the air. Accordingly, it is possible to concurrently stir and deaerate the ink in the ink stirring chamber 55 in a continuous manner. That is, the stirring deaerator 50 can concurrently stir and deaerate the ink. Moreover, since it is possible to continuously stir and deaerate the ink by concurrently stirring and deaerating the ink in the continuous manner, the color component of the ink can be prevented from being deposited. In addition, an ink ejection failure or a print failure can be prevented from being generated.

(2) Since the passage diameter of the upper communication passage 59 is smaller than the cylinder diameter of the lower chamber 58, the passage diameter of the upper communication passage 59 can be made smaller and the lower chamber 58 can be made larger. That is, by making a contact area of the ink with air smaller, it is possible to suppress the dissolution of the air in the ink. Moreover, by making the lower chamber 58 larger, it is possible to effectively perform the stirring and deaerating of the ink.

(3) Since the power on-off valve V2 and the upper on-off valve V1 are disposed in the upper communication passage 59, the gas can be isolated in the upper communication passage 59 between the lower on-off valve V2 and the upper on-off valve V1 by closing the upper on-off valve V1 and the lower on-off valve V2. Moreover, by closing the lower on-off valve V2, it is possible not to return the poor ink containing the bubbles backwardly to the lower chamber 58. By opening the upper on-off valve V1, it is possible to discharge the bubbles in the ink of the upper communication passage 59 to the air and thus removing the bubbles with ease.

(4) The liquid level sensor 64a can exactly detect the liquid surface of the ink reaching the regular position. Therefore, since the controller 5 can determine whether the bubbles are generated in the liquid surface of the ink in a moment, it is possible to reliably perform the discharging process at an appropriate time. In this case, since the liquid surface of the ink can be moved upwardly by driving the pump P, it is possible to perform the discharging process rapidly.

(5) Since the stirring blade 56a capable of generating the axial stream in the ink is used as the stirrer unit 56, the cavitation can be generated effectively and intensively by the rotation of the stirring blade 56a in the ink stirring chamber 55. As a consequence, it is possible to improve effects obtained by stirring and deaerating the ink in the ink stirring chamber 55.

(6) The stirring blade 56a is configured to generate the axial stream in a vertical direction by the rotation thereof. The rotation direction of the stirring blade 56a is set to a direction in which the ink in the ink stirring chamber 55 flows toward the upper portion of the ink stirring chamber 55 by the axial stream generated by the rotation of the stirring blade 56a. With such a configuration, since the ink below the stirring blade 56a is easily depressurized by rotating the stirring blade 56a, the gas dissolved in the ink become the bubbles in a region below the stirring blade 56a. For this reason, since it takes a distance for the bubbles to rise toward the upper portion of the ink stirring chamber 55, the ink stirring effect can be obtained by the bubbles.

(7) Since the stirring blade 56a is disposed near the bottom surface of the ink stirring chamber 55, the bubbles are generated near the bottom surface of the ink stirring chamber 55 by rotating the stirring blade 56a. As a consequence, since it takes a distance for the bubbles to rise toward the upper portion of the ink stirring chamber 55, the ink stirring effect can further be obtained by the bubbles.

(8) The gas discharging port 52 is disposed in the upper portion of the ink stirring chamber 55 and the ink passage 4 is connected to a position below the stirring blade 56a in the ink stirring chamber 55. With such a configuration, the bubbles generated near the stirring blade 56a by the rotation of the stirring blade 56a rise toward the upper portion of the ink stirring chamber 55 in which the gas discharging port 52 is disposed. Therefore, the bubbles do not enter the ink passage 4 communicating with the ink stirring chamber at the position below the stirring blade 56a. Accordingly, it is possible to prevent the bubbles generated near the stirring blade 56a from entering the cartridge 2 and the head 3 via the ink passage 4.

The above-described embodiment may be modified in the following forms.

### Other Embodiment 1

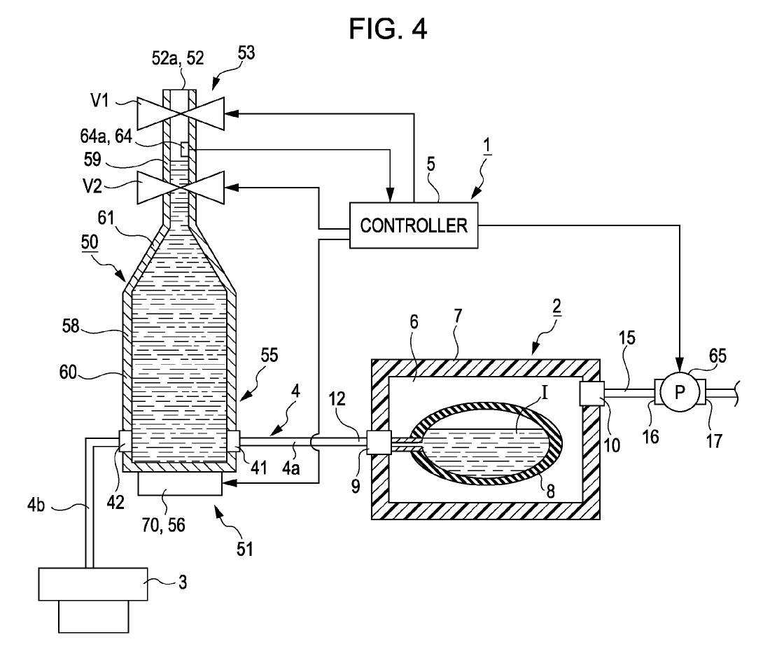

As shown in FIG. 4, the stirrer unit 56 may be configured by an ultrasonic vibrator 70 which applies ultrasonic oscillation to the ink in the ink stirring chamber 55 to stir the ink. A magnetostrictive vibrator or an electrostrictive vibrator 70 may be used as the ultrasonic vibrator 70, for example. With such a configuration, since the cavitation can effectively be generated by the ultrasonic vibrator 70, the same advantages as those of the above-described embodiment can be obtained. Moreover, since no motor is used, the apparatus can be smaller in size than that the apparatus described in the above embodiment.

### Other Embodiment 2

The exhauster may be configured by one on-off valve which opens or closes the gas discharging port 52. Alternatively, the exhauster may be configured by the one on-off valve or the liquid level changing unit 65. With such a configuration, after the cavitation is generated in the ink by rotating the stirring blade 56a in the state where the ink stirring chamber 55 is closed in an airtight manner by closing the one on-off valve, the ink can be stir and deaerated by opening the one on-off valve and opening the bubbles gathering in the upper portion of the liquid surface of the ink in the ink stirring chamber 55 to the air. That is, with such a simple configuration, the ink can be concurrently stirred and deaerated in a continuous manner. Accordingly, the color component of the ink can be prevented from being deposited. In addition, an ink ejection failure or a print failure can be prevented from being generated.

### Other Embodiment 3

There may be used the ink stirring chamber 55 in which the diameter of the lower chamber 58 is the same as the diameter of the upper communication passage 59. That is, the ink stirring chamber 55 formed of a container with the same thickness like a beaker may be configured. With such a configuration, when the diameter of the ink stirring chamber 55 is made smaller, the contact area of the ink with air can be reduced. Therefore, it is possible to reduce the amount of air dissolved in the ink. By contrast, when the diameter of the ink stirring chamber 55 is made larger, it is possible to improve the ink stirring and deaerating effects.

### Other Embodiment 4

By connecting a suction unit, which is capable of sucking the gas discharging port 52, to the gas discharging port 52 and providing one on-off valve opening the gas discharging port 52, an exhauster may be constituted by the suction unit and one on-off valve. With such a configuration, the bubbles can be removed rapidly by opening the one on-off valve and sucking the bubbles gathering on the liquid surface of the ink of the ink stirring chamber 55, after the stirring blade 56a is rotated to generate the cavitation in the ink in the state where the ink stirring chamber 55 is closed in an airtight manner by closing the one on-off valve. In this case, the suction pump may be driven at least only during the control of the stirring and deaeration. That is, by driving the suction pump only when the liquid level sensor 64a detects that the bubbles exist on the liquid surface of the ink, it is possible to shorten a driving period of the suction pump.

### Other Embodiment 5

The stirring deaerator 50 may be disposed near the head 3 in the ink passage 4. With such a configuration, since the ink can be stirred and deaerated at the position close to the head 3, it is possible to supply the stirred and deaerated good ink to the head 3 rapidly. In this case, the supply of the ink is more effective as a distance between the cartridge 2 and the head 3 is longer.

### Other Embodiment 6

The stirring deaerator 50 may be disposed within the head 3. That is, the stirring deaerator 50 may be disposed near an ink inlet port of the head 3 or in the ink chamber 24. With such a configuration, since the ink can be stirred and deaerated in the head 3, the stirred and deaerated good ink can be supplied to the nozzles 28 rapidly. In this case, the supply of the ink is more effective as a distance between the cartridge 2 and the head 3 is longer.

### Other Embodiment 7

The stirring deaerator 50 may be disposed within the cartridge 2. With such a configuration, the stirred and deaerated good ink in the cartridge 2 can be supplied to the head 3. In this case, when a distance between the cartridge 2 and the head 3 is short, the stirred and deaerated good ink can be supplied to the head 3 rapidly.

### Other Embodiment 8

The stirring deaerator including a stirrer unit which stirs the ink in each ink stirring chamber and a driving unit which drives the stirrer unit may further be provided by using a part of the ink passage 4, the containment bag body 8 in the cartridge 2, or the ink chamber 24 in the head 3 as the ink stirring chamber, forming a gas discharging port (air open port) in each ink stirring chamber, and forming an on-off valve which opens or closes each gas discharging port. In this case, the ink stirring chamber, the stirrer unit, and the driving unit constitute the cavitation generator. When the gas (bubbles) is exhausted spontaneously, the exhauster described in the above embodiment or Other Embodiment 2 may be used to perform the stirring deaeration process. When the gas (bubbles) is sucked from the gas discharging port and removed, the exhauster described in Other Embodiment 2 may be used to perform the stirring deaeration process.

### Other Embodiment 9

The stirrer unit, the driving unit driving the stirrer unit, the gas discharging port, and the on-off valve opening or closing the gas discharging port may be in the ink passage 4. Accordingly, the stirrer unit, the driving unit, the gas discharging port, and the on-off valve may constitute the stirring deaerator.

### Other Embodiment 10

A flexible section may be formed in a part of the ink stirring chamber to configure the liquid level changing unit by the pressurizing unit which raises the liquid surface of the ink by pressurizing the flexible section.

### Other Embodiment 11

The liquid level changing unit may be configured by a pump which is disposed in a passage separated from the ink passage.

### Other Embodiment 12

The length of the upper communication passage 59 may be made longer. Then, it is easy to carry out a work for mounting the upper on-off valve V1, the lower on-off valve V2, and the liquid level sensor 64a.

### Other Embodiment 13

The rotation speed of the stirring blade 56a upon stirring the ink of the ink stirring chamber 55 may be set so as to be slower than the rotation speed of the stirring blade 56a upon depressurizing the ink near the stirring blade 56a. That is, only upon stirring the ink of the ink stirring chamber 55, it is not necessary to rotate the stirring blade 56a rapidly upon depressurizing the ink.

### Other Embodiment 14

In the cartridge 2, the container-side ink entrance port 9 preserving the bag-side ink entrance port 12 and the air supply port 10 permitting the inside of the pressure chamber 6 to communicate with the outside may be disposed in one side (the same side) of the container 7. With such a configuration, the cartridge 2 can easily be mounted by one touch.

### Other Embodiment 15

In the above-described embodiment, the ink jet printing apparatus has been described as an example, but there may be used a liquid ejecting apparatus capable of jetting or ejecting a liquid different from the ink and a liquid container containing the liquid. Alternatively, a variety of liquid ejecting apparatuses including a liquid ejecting head or the like ejecting minute liquid droplets may be used. The liquid droplet means a state of a liquid ejected from the liquid ejecting apparatus and includes a particle shape, a tear shape, and a tailed threadlike shape. Any liquid may be used as long as the liquid can be ejected from the liquid ejecting apparatus. For example, a material of a liquid phase is preferably used. In addition, a fluid state material, such as a liquid state material having high or low viscosity, sol, gel water, an inorganic solvent, an organic solvent, a solution, a liquid resin, or a liquid metal (metal melt), may be used. As well as a liquid as one state of a material, a material which is obtained by dissolving, dispersing, or mixing particles of function material containing solid material, such as pigment or metal particles in a solvent may be used. As the representative liquid, ink described in the above-described embodiment or liquid crystal may be exemplified. Here, the ink includes various liquid compositions, such as general aqueous ink used in the above-described embodiment, oil-based ink, gel ink, and hot-melt ink. Specific examples of the liquid ejecting apparatus include a liquid ejecting apparatus which ejects a liquid, in which a material, such as an electrode material or a color material, is dispersed or dissolved, and is used to manufacture a liquid crystal display, an EL (Electro Luminescence) display, a field emission display, and color filters, a liquid ejecting apparatus which ejects a bioorganic material to be used to manufacture a bio-chip, a liquid ejecting apparatus which ejects a liquid used as a sample as a precision pipette, a textile printing apparatus, and a micro dispenser. In addition, a liquid ejecting apparatus that ejects lubricant to a precision instrument, such as a watch or a camera by the use of a pinpoint, a liquid ejecting apparatus that ejects on a substrate a transparent resin liquid, such as ultraviolet cure resin, to form a fine hemispheric lens (optical lens) for an optical communication element, and a liquid ejecting apparatus that ejects an etchant, such as acid or alkali, to etch a substrate may be used. The invention may be applied to one of the liquid ejecting apparatuses.

What is claimed is:

1. A liquid ejecting apparatus comprising:
a liquid container which contains a liquid;
a liquid ejecting unit which ejects the liquid supplied from the liquid container;
a cavitation generator which generates cavitation in the liquid; and
a gas discharging port which discharges a gas separated from the liquid by the cavitation.

2. The liquid ejecting apparatus according to claim 1, wherein the cavitation generator is disposed in a liquid passage permitting the liquid container to communicate with the liquid ejecting unit.

3. The liquid ejecting apparatus according to claim 1, wherein the cavitation generator is disposed in the liquid ejecting unit.

4. The liquid ejecting apparatus according to claim 1, wherein the cavitation generator is disposed in the liquid container.

5. The liquid ejecting apparatus according to claim 1, wherein the cavitation generator includes a stirrer unit which stirs the liquid and a driving unit which drives the stirrer unit.

6. The liquid ejecting apparatus according to claim 1, wherein the cavitation generator includes a liquid stirring chamber, a stirrer unit which stirs the liquid in the liquid stirring chamber, and a driving unit which drives the stirrer unit.

7. The liquid ejecting apparatus according to claim 6, wherein the liquid stirring chamber includes a lower chamber which has a cylinder shape extending vertically and an upper communication passage which permits the lower chamber to communicate with the gas discharging port.

8. The liquid ejecting apparatus according to claim 7, wherein a passage diameter of the upper communication passage is smaller than a cylinder diameter of the lower chamber.

9. The liquid ejecting apparatus according to claim 7, further comprising:
an exhauster which exhausts the gas from the gas discharging port and which includes a lower on-off valve which is disposed in a lower portion of the upper communication passage and opens or closes the upper communication passage, an upper on-off valve which is disposed in an upper portion of the upper communication passage and opens or closes the upper communication passage, a liquid level detecting unit which detects whether a liquid surface of the liquid in the liquid stirring chamber reaches the upper communication passage between the lower on-off valve and the upper on-off valve, and a liquid level changing unit which upwardly moves the liquid surface of the liquid in the liquid stirring chamber.

10. A liquid ejecting apparatus comprising:
a liquid ejecting unit which is connected to a liquid container containing a liquid through a liquid passage and ejects the liquid;
a liquid stirring chamber which is disposed in the liquid passage and stirs the liquid;
a stirring blade which is disposed in the liquid stirring chamber and rotates to stir the liquid in the liquid stirring chamber; and
a gas discharging port which discharges a gas from the liquid stirring chamber, when the liquid near the stirring blade is depressurized by the rotation of the stirring blade and thus the gas dissolved in the liquid is separated from the liquid.

11. The liquid ejecting apparatus according to claim 10,
wherein a rotation speed of the stirring blade when the liquid in the liquid stirring chamber is stirred by the stirring blade is set to be slower than a rotation speed of the stirring blade when the liquid near the stirring blade is depressurized,
wherein the stirring blade is configured to generate an axial stream generated in a vertical direction by the rotation of the stirring blade, and
wherein a rotation direction of the stirring blade is a direction in which the liquid in the liquid stirring chamber flows toward an upper portion of the liquid stirring chamber by the axial stream generated by the rotation of the stirring blade.

12. The liquid ejecting apparatus according to claim 10, wherein the stirring blade is disposed near a bottom surface of the liquid stirring chamber.

13. The liquid ejecting apparatus according to claim 10, wherein the gas discharging port is disposed in the upper portion of the liquid stirring chamber and the liquid passage is connected to a position below the stirring blade in the liquid stirring chamber.
